(19) United States
(12) Patent Application Publication
(10) Pub. No.: US 2004/0109093 A1
(43) Pub. Date: Jun. 10, 2004

(54) Method and apparatus for simultaneous television video presentation and separate viewing of different broadcasts

(76) Inventor: Aaron Tug Small-Stryker, Springfield, OR (US)

Correspondence Address: WILLIAM S. LOVELL, 6435 N. E. NEPTUNE DR., LINCOLN CITY, OR, 97367, US

(21) Appl. No.: 10/313,157

(22) Filed: Dec. 5, 2002

(51) Int. Cl. H04N 5/445

(52) U.S. Cl. 348/739; 348/564

(57) ABSTRACT

A television monitor accepts two video programs simultaneously, by ordinary transmission, cable, a VCR, other means or any pair of such means, and by providing the two programs as light transmissions in two mutually orthogonal polarizations, together with eyeglasses adapted to select one or the other of the two polarizations, two or more users are enabled to watch one or the other of two different programs, at the same time on a single display screen. Selection of which program a user wishes to watch is accomplished by adjusting a polarizing lens within the eyeglasses so that the polarization of the light that will pass through the eyeglasses is matched to one or the other of the two polarizations of the light being emitted by the display screen. The eyeglasses include automatic adjustment means that will compensate for movements of the user's head that would otherwise place the glasses out of angular alignment with the light from the display screen.

### BACKGROUND OF THE INVENTION

### FIELD OF THE INVENTION

This invention relates to the field of television displays, particularly to program selection, and especially to the presentation of the video of two programs at the same time, wherein through the use of special eyeglasses any number of viewers can individually select which of those two programs to watch.

### BACKGROUND INFORMATION

In the home, or in the office for business purposes, it is sometimes desired by two or more people at a particular time to view different programs on a single television monitor, as when one party wants to watch a football game while another wants to watch the current episode of some favorite series. One method of permitting such users each to watch their desired program has been described in U.S. Pat. No. 6,188,442 issued Feb. 13, 2001, to Narayanswami. This patent describes a system that uses time multiplexing, wherein visual apparatus (“shutter glasses”) worn by the users are synchronized with one or the other of the display times used by each of two channels then being broadcast, so that each user sees only a selected one of the two presentations that the television monitor itself is then actually displaying in that multiplexed manner.

U.S. Pat. No. 6,400,394 issued Jun. 4, 2002, to Kim et al. describes a stereoscopic display system for displaying a three dimensional (3D) image. Two images (“left eye” and “right eye”) are generated through the use of two video cameras that in the usual manner are slightly displaced one from the other in axis of view, and the two images are then distinguished one from the other by causing them to become linearly polarized at right angles one to the other. Using reflectors, lenses, and other such components, the two images are formed into a matrix for each of them, both matrices then being projected, one following the other, in time multiplexed fashion onto a screen. A user can then view a 3D image on the screen by wearing ordinary colored 3D glasses.

However, to persons present at a television monitor adapted for a shutter glasses system but who are not wearing shutter glasses, such a process presents flickering and essentially unreadable images, as a consequence of the time multiplexing used in shutter glasses. Also, shutter glasses are bulky, and in particular require substantial amounts of power to operate the required LCD viewers. It would thus be useful, in being able to select between two available television channels, to have a system that eliminates flickering as a source of eyestrain for those not wearing the requisite glasses, that does not consume large amounts of power, and that is lighter in weight than shutter glasses. A complete solution to being able to select one of two televison channels that are being received simultaneously would of course include means for isolating and selecting the particular audio streams that are associated with each of the video broadcasts, but the present invention addresses only the video aspect of the problem.

### SUMMARY OF THE INVENTION

The invention uses linear polarization of light to provide a method and apparatus for the viewing of a selected one of two television programs being received simultaneously, the identification of each program being based upon having distinguished each program from the other within the television monitor, specifically by having associated with each program a linear polarization of the pixels to be displayed. The two polarizations for the two different programs are orthogonal one to the other, and user selection of which program to watch is accomplished by the use of special, polarization sensitive eyeglasses that are set to accept just one or the other of the two polarizations, using self-balancing lenses installed therein. The eyeglasses are aligned with the monitor screen by way of gravity, wherein the glasses, once initially aligned, will realign themselves constantly as a viewer may happen to change the angular orientation of his or her head, whereby the polarization of the eyeglasses will at all times remain matched to the desired polarization of the monitor display.

### BRIEF DESCRIPTION OF THE DRAWINGS

The preferred embodiments of the invention will now be described in detail with reference to the accompanying drawings, in which:

FIG. 1 presents in block diagram form an overview of a preferred embodiment of the invention, showing a specially equipped television monitor together with special glasses.

FIG. 2 is a front elevation view of a television screen that depicts symbolically, in highly exaggerated form, the desired end result of operations within the television monitor of FIG. 1.

FIG. 3 is a longitudinal cross-sectional drawing of a television screen of the cathode ray tube (CRT) type that illustrates the polarizing component of the invention.

FIG. 4 is a longitudinal cross-sectional drawing of a television screen of the plasma type that illustrates the polarizing component of the invention

FIG. 5 is a longitudinal cross-sectional drawing of a television screen of the liquid crystal diode (LCD) type that illustrates the polarizing component of the invention.

FIG. 6 is a flow diagram showing the respective results of carrying out the several steps of the method of the invention.

FIG. 7 shows in block diagram form the circuitry required to carry out the steps of the method described in FIG. 6.

FIG. 8 is an oblique view of the polarized eyeglasses of FIG. 1, that permit alignment with and selection of one or the other of two programs available on the display screen of the invention.

FIG. 9 is a longitudinal cross-sectional view of one of the lens structures of the eyeglasses of FIG. 8, exaggerated to show better the structure for lens rotation.

FIG. 10 is a front elevation view of one of the lens structures of the eyeglasses of FIG. 8, exaggerated to show better the manner of disposition of the alignment control means.

### DETAILED DESCRIPTION OF THE INVENTION

Ordinarily, a television monitor will display but a single program, and emit but a single audio stream associated with that program, at a single time. One might, however, superimpose two such video and audio streams so that both appear and are heard at the same time. The result would of course be confusion, both as to the scenes depicted and the sound heard. However, if one were to distinguish one program from the other as to both video and audio, and also provide means for a viewer to make a like distinction, a viewer could see and hear but a single, selected program, even though two such programs were being received and made available on the display screen simultaneously.

The present invention addresses only the video aspects of being able firstly to receive two television channels at once and make them simultaneously available on a monitor screen, and then being able to select a chosen one of those two presentations actually to watch. The invention thus provides a method and apparatus for distinguishing between the two channels, firstly by providing means within the monitor that define a separate, distinguishable data stream for each channel; secondly, by applying a merger process that makes both data streams immediately and simultaneously available on the display screen; thirdly, by displaying those data streams in a manner that permits them to be distinguished one from the other by external means; and fourthly, by providing eyeglasses means to a user that will permit selection, as desired, of one program or the other. In brief, the two data streams are distinguished one from the other on the monitor display screen by being presented in mutually orthogonal linear polarizations, and the ability to observe just one data stream and not the other is accomplished through the use of polarized eyeglasses that will transmit to the user images of only one polarization at a time, selection of which data stream to be watched being made by selecting at the eyeglasses one or the other of the two orthogonal polarized light displays at the display screen to be viewed.

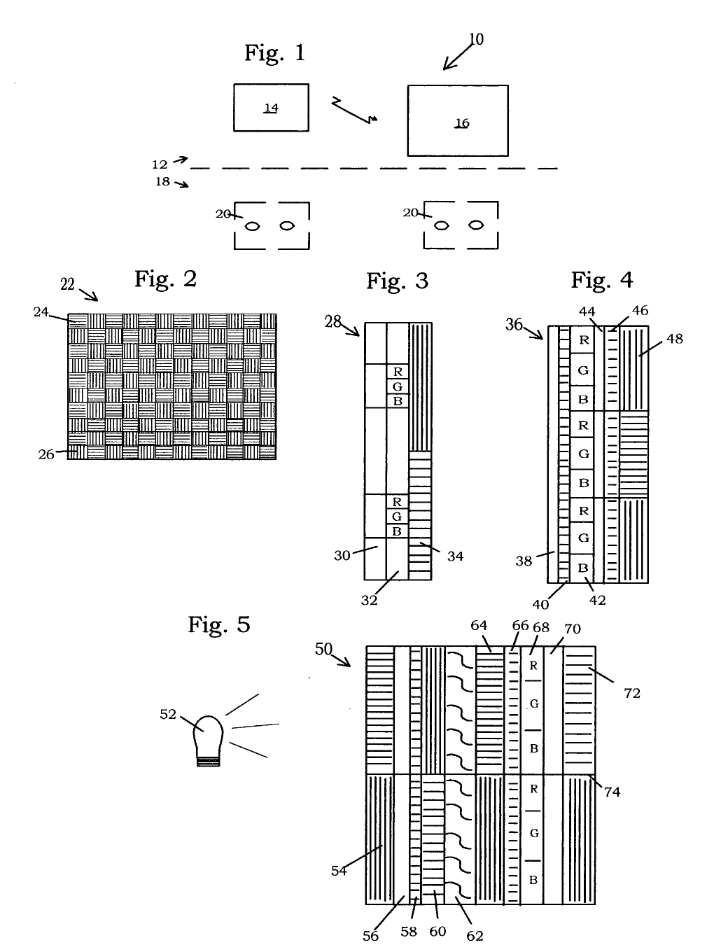

Although the following description will be phrased in terms of ordinary television reception, as from an antennae or by cable, it will be understood that with respect to the operation of the invention, the actual source of the incoming video data is immaterial, and the data might instead have come from any other type of source such as a VCR. As just one example, the invention permits one user to watch a favorite movie being taken from a video cartridge, CD or DVD connected to a television monitor equipped to accommodate such a source (and of course also being equipped with the features of the present invention), while another person, on that same television monitor, could be watching the current news then being broadcast. FIG. 1 presents a general overview of this method and apparatus.

As shown in FIG. 1, the invention, designated generally as display apparatus 10, includes a display component 12 including a signal source 14 and a television monitor 16, and then a view component 18, the display and view components 12, 18 being separated in FIG. 1 by a dashed line. Display apparatus 10 includes within display component 12 only one instance of television monitor 16, but view component 18 is shown in FIG. 1 to include two instances of eyeglasses 20, to illustrate that any implementation of display apparatus 10 may include as many instances of eyeglasses 20 as there are viewers present who wish to watch one particular program out of the two that are being received and made available for viewing by display apparatus 10.

Monitor 16 receives a signal or video stream incorporating a program from signal source 14, which could be the usual television station transmitting an ordinary television signal as suggested by the jagged arrow in FIG. 1, but which, as previously noted, could as well be a VCR, a CD or DVD or other alternative source. Whether from a single source or from some combination of sources, at least two different video streams must be provided in order for the process that the invention provides to be carried out. Each such video stream is taken to include both content data and signal control data to control the disposition of those content data. Monitor 16 includes the usual components that are well known to a person of ordinary skill in the art, which components will be well known to any person of ordinary skill in the art and will not be explicitly shown or described. That is, what is shown and described herein as to monitor 16 will be limited to those modifications of a standard television monitor that will be necessary for the functioning of the invention.

FIG. 2 shows a television screen 22 that in highly exaggerated form illustrates symbolically the desired end result of operations within monitor 16 in accordance with the invention. The pixels deriving from the two video streams that “carry” the two programs are distinguished one from the other by respective vertical and horizontal linear polarizations having been given to the light emitted therefrom, and are made available simultaneously on a monitor screen by having been interlaced thereon by the use of alternating pixels, e.g., even numbered pixels for vertical polarization and odd numbered pixels for horizontal polarization. Thus, in the upper left hand pixel of screen 22 in FIG. 2 there is first shown a horizontally polarized pixel 24, and then further as to every other pixel thereafter in the row. The pixel in the lower left hand corner of screen 22 is seen to be a vertically polarized pixel 26, such polarization being given to every pixel in screen 22 that had not been (or was not to be) given a horizontal polarization, i.e., again as to every other pixel. The result has both programs available for viewing on screen 22 at the same time, albeit with only one-half of the original resolution of each of them, in that the display of either program employs only half of the pixels that were originally contained within the video stream received by monitor 16. This process may be termed “spatial multiplexing,” and is distinguished from the temporal multiplexing of the prior art in that there is no flicker—the images are in precisely the same form, and are displayed in the same way, as would be the case with any other normal television display.

The light as emitted by any pixel location on a television display screen will be non-polarized in that such light, unlike laser light, derives from thermal or similar non-coherent sources. However, in addition to showing a display of actual pixels as was just described, screen 22 can also be taken to represent a pixel-by-pixel polarization matrix, as the actual physical structure of screen 22. As will be shown below, such a polarization matrix lies as the outermost (towards the viewer) element of monitor 16, and thus follows after that initial emission of non-polarized light. The light as transmitted outwardly from monitor 16, having passed through the linear polarizers of screen 22 as these are shown in FIG. 2, will thus embody the polarization character of the respective pixel regions that each such pixel of light would have passed through. FIGS. 3-5 illustrate alternative methods of producing that matrix-wise, linearly polarized light images.

Thus, in FIG. 3 there is shown in transverse cross-section an ordinary CRT display screen 28 which in sequence from the left includes firstly a shadow mask 30, a phosphor plane 32 that has within it the usual RGB dyes, and finally polarizing glass layer 34 in the form of a polarization matrix of alternating polarization, as suggested by the vertical and horizontal polarizations in FIG. 3 and already shown more completely in FIG. 2. As each pixel within screen 22 is activated to emit light, the light so emitted passes through that part of glass layer 34 that is directly in front of that pixel, and since glass layer 34 has the polarizing character previously noted, that same light as seen beyond glass layer 34 will have assumed the linear polarization of whatever part of glass layer 34 through which it will have passed.

FIG. 4 shows a similar process as to a plasma display screen. Specifically, FIG. 4 shows in transverse cross-section a plasma display screen 36 that in sequence from the left includes a rear plate glass 38, address electrodes 40, phosphor layer 42, MgO layer 44, dielectric layer 46, and finally a polarizing glass layer 48 that has the same structure as does glass layer 34 of the CRT display screen in FIG. 3. Except for the manner in which the light coming from plasma display screen 36 has been caused to be emitted, the operation of this embodiment of the light polarizing aspect of the invention is the same as that embodied in the embodiment of FIG. 3.

FIG. 5 shows in transverse cross-section an LCD display screen 50 that in sequence from the left includes a source of back lighting source 52 as a preferable option that gives a brighter screen, first polarizing glass 54, first glass substrate 56, first address electrodes 58, first alignment layer 60, liquid crystals 62, second alignment layer 64, second address electrodes 66, color filters 68, second glass substrate 70, and second polarizing glass 72, through all of which dividers 74 are disposed in a direction normal to the plane of LCD display screen 50 to separate the pixels. In this case, and unlike the embodiments that were just described, the desired polarization matrix of FIG. 2 is not derived simply by passing non-polarized light through a single polarizer, but rather by providing first polarizing glass 54 so that the light entering the LCD components will be linearly polarized, and then requiring the same orientations in the output light by way of second polarizing glass 72. However, since the LCD display device will already incorporate an initial layer of polarizing glass that is equivalent to first polarizing glass 54 (as well as another two alignment layers that effect no net polarization), the development of such an embodiment of the invention by modifying an existing display device does indeed, as in forming the two previous embodiments, involve simply the addition of one layer of polarizing glass to the output side of an existing display device, i.e., in this case onto a standard LCD shutter.

The process by which two programs are simultaneously made available on screen 22 involves a superposition of their signals thereon in alternating pixels, the basis on which one or the other signal can be selected is established by causing the light emitted by those two subsets of pixels to be given one or the other of two mutually orthogonal polarizations, and finally the selection of one program or the other is accomplished by the user by selection at eye piece 20 of one or the other of the two polarizations. This process or method can be summarized in the following steps:

1) Provide two mutually distinguishable television programs to a television monitor;

2) Modulate each program separately so as to delete pixels from every other pixel site in each program so as to produce two complementary subsets of pixels, each having one-half of the number of the pixels as were in the programs as originally received, and such that the pixel locations at which the pixels are left intact with respect to one program are the pixel locations from which the pixels were removed in the other program, and vice versa;

3) Direct the resultant two subsets of pixel locations into separate video streams that are then passed on to a multiplexor;

4) Merge or multiplex together the content of those two video streams to produce a full screen of pixels, wherein the video information that is to appear in those pixel locations is derived alternately from one or the other of the two programs;

5) On the monitor screen, provide the two video streams that carry the two different subsets of pixel data as a single display made up of interlaced subsets of alternating pixels;

6) Cause the light emitted respectively from those two subsets of pixel data to have mutually orthogonal polarizations;

7) Provide eyeglasses having polarizing lenses therein to users for purposes of program selection; and

8) Align those eyeglasses while being worn by the user so that the polarizations of the polarized lenses therein are in orientations corresponding to those of the mutually orthogonal polarizations within the light emitted by the screen; and

9) Select one or the other of the two programs available on the screen, so as then to see one or the other of the two programs.

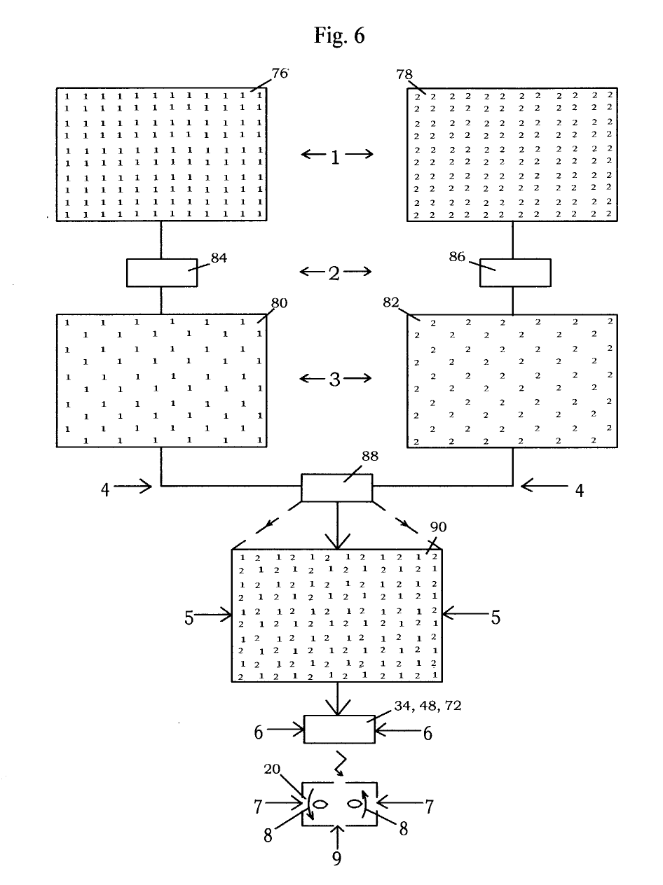

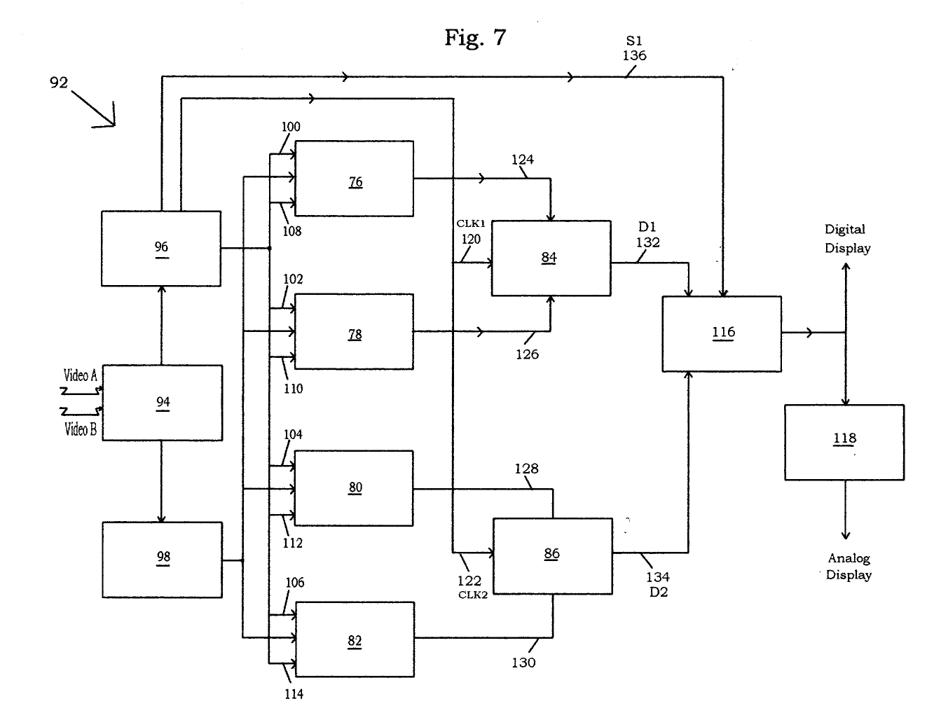

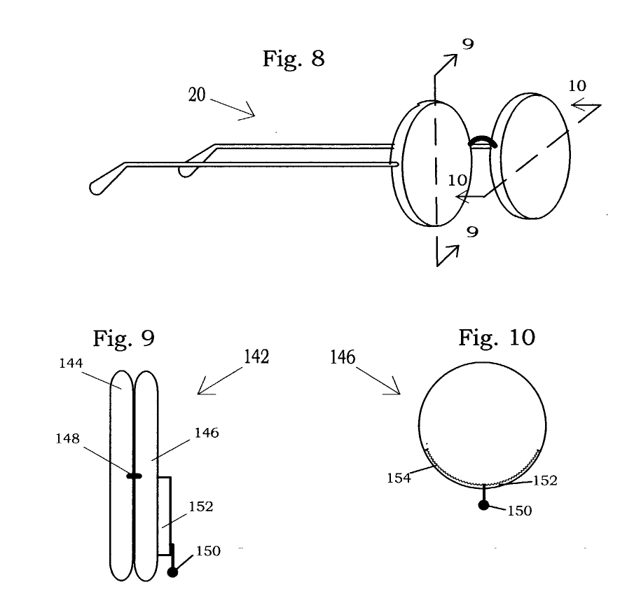

Taken together, the aforesaid steps 2-5 carry out a combination process by which each program is first separated into two interlaced parts, and those parts are then recombined into a single display image for each program. Graphical representations of the results of each of the steps set out above, in which the components shown to be associated with steps 2-5, and as similarly shown in FIG. 8, constitute the combination means, are shown in FIG. 6, which includes first-fourth field memories 76-82; first and second multiplexors 84, 86; signal multiplexor (SMUX) 88; and frame multiplexor (FMUX) 90, the interconnections and functions of which are described in detail below with reference to FIG. 7.

Considering now FIG. 6, shown first in that flow diagram are the first and second field memories 76, 78, in which the “1s” in first field memory 76 and the “2s” in second field memory 78 represent, respectively, the video streams corresponding to the first and second programs, as received. Providing the content of first and second field memories 76, 78 corresponds to the completion of Step 1 above, as shown by the “1” and arrows in FIG. 6.

Immediately below first and second field memories 76, 78 in FIG. 6 are shown first and second multiplexors 84, 86, wherein first field memory 76 connects to first multiplexor 84, and second field memory 78 connects to second multiplexor 86. The modulation that then takes place in first, second multiplexors 84, 86 constitutes carrying out Step 2 as listed above, and as is shown by the “2” and arrows in FIG. 6.

The outputs of first and second multiplexors 84, 86 are then sent separately to third and fourth field memories 80, 82, respectively, wherein, pursuant to the actions of first, second multiplexors 84, 86, third and fourth field memories 80, 82 each contain the video code for one of the two programs, these being different programs in the different field memories, and are stored on complementary pixel subsets; this division and storage of data constituting Step 3 as listed above.

So as to make both programs available on monitor 16 at the same time, the video code contained in third and fourth field memories 80, 82 must then be passed into a signal multiplexor wherein such a combination or merger can take place. FIG. 6 shows that such process is initiated by passing those data into signal multiplexor (SMUX) 88, and doing that constitutes completion of Step 4 as listed above and as is shown by the “4” and arrows in FIG. 6.

SMUX 88 then carries out the required multiplexing, thereby accomplishing Step 5 as listed above and as is shown by the “5” and arrows in FIG. 6. In particular, the dashed lines leading from SMUX 88 to output buffer 90 are intended to indicate transmission of the data that was multiplexed together in SMUX 88 to the data as shown symbolically in output buffer 90, i.e., to carry out step 5. The data that result are thus shown in FIG. 6 to be held in output buffer 90 of SMUX 88. The “1” and “2” indications within output buffer 90 as shown are laid out in the same pattern as they will be displayed on monitor 16, and indeed these data are then be provided to monitor 16 so as to energize the indicated pixels, the light from which must then be linearly polarized in order to selectable by a user.

It should be understood that the process just described specifically addresses only one of the two circumstances under which it must be carried out. That is, in the foregoing discussion, specific mention is made only of first and second field memories 76, 78, which include only the odd-numbered data for the two images. The same process must be carried out with respect to the even-numbered data, which are held in third and fourth field memories 80, 82. It is for that reason that upper left block in FIG. 6 is labeled 76, 80, and the upper right block is labeled 78, 82-the second one of each such pair of numbers represents the case in which third and fourth field memories 80, 82 (which contain the even-numbered data for both images) are being treated, so as thereby, in combination with the process with respect to first-second field memories 76, 78 just described, to encompass all of first-fourth field memories 76-82 as was noted in the discussion further above, immediately following the list of steps that make up the process. Two executions of the process, which are identical except as to the source of the data being treated, are thus carried out, and both can be seen by first interpreting FIG. 6 with respect to the 76, 78 pair of numerical references (odd-numbered data), and then with reference to the 80, 82 pair of numerical references (even-numbered data). Both types of data will be required, of course, in order to have not only both images, but also both polarizations of each such image, available on television monitor 16.

Turning now to the manner of obtaining those two polarizations, and noting firstly the polarizing glass layer 34 of the CRT embodiment (CRT screen 28) of the invention but also polarizing glass layer 48 of the plasma embodiment (plasma display screen 36) and polarizing glass layer 72 of the LCD embodiment (LCD display screen 50) that function in the same way, one or the other of these polarizing glasses, depending on which type of monitor one has, converts the non-polarized light being emitted from the particular source into subsets of mutually orthogonal linearly polarized light to accomplish Step 6 as listed above and as shown by the “6” and arrows in FIG. 6. By the reference numbers 34, 48 and 72 of FIG. 6, at any particular time reference is made, of course, only to a selected one of the three embodiments (CRT and screen 28, plasma and plasma display screen 36, or LCD and LCD display screen 50).

As shown in both FIG. 1 and FIG. 8, eyeglasses 20 are provided so as to permit discrimination by the user between the two programs available on one or the other of the aforementioned screens, thereby to carry out Step 7 as listed above and as shown by the “7” at the bottom of FIG. 6. As shown in the curved arrows at the bottom of FIG. 6, eyeglasses 20 must be oriented so as to align the polarizers therein with the polarizations of the light being emitted from the particular screen, thereby to accomplish Step 8. By means that will be described further below, the user then simply chooses which of the two programs to watch, thereby to accomplish Step 9. The detailed nature of eyeglasses 20 and the manner of making such alignment and selection will be described below with reference to FIG. 8.

FIG. 7 is a block diagram of the circuitry within monitor 16 that carries out the signal conditioning aspects of the foregoing method, i.e., steps 2 and 3. This circuitry is designated generally as video signal processor 92, which receives the two video streams representing the two programs through a signal separator 94, which then separates out from each such video stream their respective synchronizing signals and the RGB videos, either of which may or may not include an interlacing function with respect to normal screen display. (Without an interlacing function, the video signal sequentially “paints” the display screen top-to-bottom across every pixel row; with an interlacing function, the video signal paints top-to-bottom through alternating pixel rows, returns to the top, and then paints downward a second time to fill in those rows that were skipped in the first image display “painting” process.)

For example, with respect to a video stream in NTSC format or from a computer, after passing through signal separator 94 the synchronizing signal is sent to a controller 96 that is connected to signal separator 94, and the RGB video signal Dna is sent to an A/D converter 98 that is also connected to signal separator 94. A/D converter 98 converts the analog RGB video signal Dna into digital form and, through the operation of controller 96, sends that digital signal to first-fourth field memories 76-82. Through the use of standard programming modules that will be known to a person of ordinary skill in the art, sequential triggering signals are provided by controller 96 whereby the individual pixel data are distributed among first-fourth field memories 76-82 as shown in the following Table I:

TABLE I
First field memory 76 - First image, odd-numbered frame data
Second field memory 78 - Second image, odd-numbered frame data
Third field memory 80 - First image, even-numbered frame data
Fourth field memory 82 - Second image, even-numbered frame data.

As a first example, in the case of VGA the necessary memory capacity of each of the four memories 76-82 is 1,843,200, which is derived as follows:

Frame size: (640×480)times 3(RGB)=921,600

Number of images=2

Total=2×921,600=1,843,200.

In order to accommodate the requisite display frequency of 60 reads or writes per second, the clock frequency should be at least 18.4 MHz=640×480×60. The minimum clock frequencies for various video modes are shown in the following Table II:

TABLE II

| Video | | |
|---|---|---|
| Mode | Memory Capacity | Minimum Clock Frequency |
| VGA | 1843200 = | 18.4 MHz = |
| | 640 × 480 × 3 × 2 | 640 × 480 × 60 |
| SVGA | 2880000 = | 28.8 MHz = |
| | 800 × 600 × 3 × 2 | 800 × 600 × 60 |
| XGA | 4718592 = | 47.2 MHz = |
| | 1024 × 768 × 3 × 2 | 1024 × 768 × 60 |
| 480p | 2027520 = | 20.3 MHz = |
| | 704 × 480 × 3 × 2 | 704 × 480 × 30 |
| 720p | 5529600 = | 27.7 MHz = |
| | 1280 × 720 × 3 × 2 | 1280 × 720 × 30 |
| 1080i | 12441600 = | 124.5 MHZ = |
| | 1920 × 1080 × 3 × 2 | 1920 × 1080 × 60 |

Under the direction of controller 96, first-fourth field memories 76-82 are made to store the data as listed in Table I by way of the respective write-enable signals WE1 100-WE4 106 as indicated in FIG. 7, these signals respectively being the uppermost inputs to first-fourth field memories 76-82. That is, WE1 100 enables the storage of the odd-numbered frame data from the first image in first field memory 76; WE2 102 enables the storage of the odd-numbered frame data from the second image in second field memory 78; WE3 104 enables the storage of the even-numbered frame data from the first image in third field memory 80; and WE4 106 enables the storage of the even-numbered frame data from the second image in fourth field memory 82. Again directed by controller 96, those frame data are read out for multiplexing purposes by a set of read-enable signals RE1 108-RE4 114, which respectively are the lower-most inputs to first-fourth field memories 76-82.

Specifically, read-enable RE1 108 transfers the content of first field memory 76 through first read line 124 to first multiplexor 84; RE2 110 transfers the content of second field memory 78 through second read line 126 to first multiplexor 84; RE3 112 transfers the content of third field memory 80 through third read line 128 to second multiplexor 86; and RE4 114 transfers the content of fourth field memory 82 through fourth read line 130 to second multiplexor 86. These data are summarized in the following Table III:

TABLE III
First field memory 76 - RE1 108 - Line 124 - first multiplexor 84
Second field memory 78 - RE2 110 - Line 126 - first multiplexor 84
Third field memory 80 - RE3 112 - Line 128 - second multiplexor 86
Fourth field memory 82 - RE4 114 - Line 130 - second multiplexor 86.

The outputs of first and second multiplexors 84, 86 connect to digital switch 116, which distinguishes between the digital outputs of first and second multiplexors 84, 86 so as to transmit them appropriately to a D/A converter 118 to which digital switch 116 connects. Controller 96 connects to both of first and second multiplexors 84, 86, whereby first clock signal CLK1 is transmitted on first MX line 120 from controller 96 to first multiplexor 84, and second clock signal CLK2 is transmitted on second MX line 122 from controller 96 to second multiplexor 86. As a consequence, if first clock signal CLK1 is sent in the course of obtaining odd-numbered data as shown in Table I, the content of either first field memory 76 or second field memory 78 will be transmitted to first multiplexor 84, depending upon the stage of the process that then exists at controller 96. That decision is based on which image is then being constructed, i.e., if the first image is being treated, the data are taken from first field memory 76, while if it is the second image that is being treated, in accordance With the sequence programmed into controller 96, data are taken from second field memory 78. A like decision, and for the same reason, is made as to acquiring data from either third field memory 80 or fourth field memory 82, when even-numbered data are being acquired and it was the clock signal CLK2 that was sent.

Data from first field memory 76 are sent to first multiplexor 84 on first read line 124 that connects between first field memory 76 and first multiplexor 84. At a different stage of the process within controller 96, data from second field memory 78 are sent to first multiplexor 84 on second read line 126 that connects between second field memory 78 and first multiplexor 84. Transmission of second clock signal CLK2 is carried out in the course of obtaining even-numbered data as shown in FIG. 1 in the same manner, i.e., at one stage of the process within controller 96, when second clock signal CLK2 is sent, data are sent from third field memory 80 to second multiplexor 86 over interconnecting third read line 128, and at another stage of that process, data are sent from fourth field memory 82 to second multiplexor 86 over fourth read line 130.

Based on which of first and second clock signals CLK1 120, CLK2 122 is received at either first multiplexor 84 or second multiplexor 86, a first digital signal D1 132 will be transmitted from first multiplexor 84 to digital switch 116, or a second digital signal D2 134 will be transmitted from second multiplexor 86 to digital switch 116. The programming of controller 96 will have put the transmission of CLK1 and CLK2 into a sequence that will cause the pattern shown in FMUX 90 of FIG. 6 to be displayed on television monitor 16.

The output of digital switch116 is separately controlled by signal S1 that connects over line 136 from controller 96 to digital switch116. When controller 96 transmits signal CLK1 over line 120 to first multiplexor 84, signal S1 is also sent along line 128 to cause the data within first multiplexor 84 to be transmitted further on, and when controller 96 transmits signal CLK2 over line 120 to second multiplexor 86, signal S1 is sent along line 128, so as in this case to cause the data within second multiplexor 84 to be transmitted further on. As can be seen from Table III, which of the two possible contents of each of first and second multiplexors 84, 86 is to be transmitted must also be determined, and that is done by way of which of read-enable signals RE1 108-RE4 114 have been sent to first-fourth field memories 76-82 so as to establish the actual current content of first and second multiplexors 84, 86.

The specific content of signal S1 will have been established in the programming noted in the previous paragraph, whereby a precise code sequence will be provided that will cause the pattern shown in FMUX 90 of FIG. 6 to be displayed on television monitor 16. That is, when a CLK1 signal has been sent from controller 96, signal S1 will have content such that D1 data will be transmitted from digital switch 116, while if a CLK2 signal has been sent from controller 96, signal S1 will have been encoded such that D2 data will be transmitted from digital switch 116. As shown on the right hand side of FIG. 7, in either case, and at each moment, the particular digital data (D1 or D2) will have been made available for direct display on a digital display system, or can be passed through DIA converter 118 for display on an analog display system.

Turning now to the means by which a user is able to select one or the other of the images so made available on television monitor 16, FIG. 8 shows the structure of the special eyeglasses 20 that can be used, and thereby to carry out the final steps 7-9 of the method. Eyeglasses 20 are formed with an eyeglass frame 138 having earpieces 140 and polarizing lenses 142. The polarizing lenses 142 have a structure so as to pass through only polarized light, at such time that the lenses are aligned with the polarization of the light that is available on television monitor 16, and are also rotatable so that the user can, by rotating the lens so as to become aligned with one or the other of the two polarizations that are available on television monitor 16, select one or the other program.

In more detail, as shown in the side view of one of the two polarizing lenses 142 in FIG. 9 and the front view of the same in FIG. 10, a polarizing lens 142 includes both a clear glass lens 144 and a polarized glass lens 146. Clear glass lens 144 is fixedly attached to eyeglass frame 138 and polarized glass lens 146 is rotatably attached to clear glass lens 144 by way of pivot pin 148 that is centrally located as to both clear glass lens 144 and polarized glass lens 146. Rotation of polarized glass lens 146 relative to clear glass lens 144 accomplishes the selection of one of the other of the two programs the user wishes to watch.

A user of eyeglasses 20 will normally move about while watching a television program, and that movement may include a tipping of the head that will change the angular relationship between the head, and hence of eyeglasses 20 and polarized glass lenses 146, with television monitor 16. Eyeglasses 20 are consequently provided with alignment control means by which compensation for such changes in angular position will be provided automatically, i.e., polarized glass lenses 146, once aligned with television monitor 16 so as to accept the desired program, will remain aligned with the selected polarization of the light from television monitor 16 even though eyeglasses 20 may have been rotated relative to television monitor 16 as the user may move about.

That process is accomplished by way of anchor weights 150 shown in FIG. 9, which are connected to and disposed at the bottom of polarized glass lenses 146. Just as the needle of a compass on the dashboard of a car, by rotating about a vertical axis relative to the car, will remain pointing north as the car turns left and right, so will polarized glass lenses 146 remain in that initially established angular alignment with television monitor 16 so as to continue to receive the selected program, as a consequence of the presence of anchor weights 150.

FIG. 10 is a front elevation view of one lens 142 of eyeglasses 20, and shows a sliding groove 152 whereby an anchor weight 150 can be positioned so as to provide the desired program. When anchor weight 150 is disposed in an appropriate one of notches 154 that are disposed along the length of sliding groove 152, a first program then available on television monitor 16 will have been selected by the user, and if anchor weight 150 is placed in a second position along sliding groove 152 that is 90 deg. away from that first position, the second of the two programs available on television monitor 16 will have been selected. Quite a number of notches 154 are provided since the angular disposition of the head of the user may not be vertical-the user may be comfortably disposed on a couch, with the head disposed at some angle to the vertical, but with the full range of notches 154 being available, anchor weight 150 can nevertheless be disposed to give so as to place polarized glass lenses 146 at the angle that will provide to the user the desired program.

A person of ordinary skill in the art could devise other circuits that would duplicate the operation of video signal processor 92, or other specific procedures or steps that would carry out the same process as is shown and described herein, and all such variations are to be taken as being within the scope of the invention. Other arrangements and dispositions of the aforesaid or like components, the descriptions of which are intended to be illustrative only and not limiting, may also be made, without departing from the spirit and scope of the invention, which must be identified and determined only from the following claims and equivalents thereof.

I claim:

1. A television monitor that simultaneously and separably displays two video channels and enables a user to select one or the other of said video channels, comprising:
Reception means for simultaneously receiving two video channels, each said channel providing video data including both content data and signal control data;
First separation means adapted to separate and digitize said content data of said video data of each of said two video channels into separate series of sequential blocks of digital data;
Data storage means adapted to store and release on command a series of sequential blocks of digital data;
Data transmission means adapted to transmit said sequential blocks of digital data, as made available by said separation means, to said data storage means;
Control means that are responsive to said signal control data of said video data and are adapted to direct the operation of said data transmission means in the transmission of said sequential blocks of digital data;
Second separation means adapted to separate each of said separate series of sequential blocks of digital data into two subsets;
Combination means adapted to combine selected ones of said subsets of said separate series of sequential blocks of digital data into two separate display sequences, each of said two display sequences including content data originating from a particular one or the other of said two video channels;
Display means adapted to display for viewing either one or the other of said two display sequences; and
Program selection means, whereby a user is enabled to select for viewing one or the other of said two display sequences:

2. The television monitor of claim 1 further comprising analog display means, and means for converting said display sequences from digital to analog form for display by way of said analog display means.

3. The television monitor of claim 1 wherein said display means comprises polarizing means, wherein said display means include a polarizing glass layer as an outermost element, whereby the light emitted from said display means provides two orthogonally linearly polarized display images, and further comprises eyeglasses adapted to select one or the other of said two orthogonally linearly polarized display images.

4. The television monitor of claim 3 wherein said display means further comprise cathode ray tube display means.

5. The television monitor of claim 3 wherein said display means further comprise plasma display means.

6. The television monitor of claim 3 wherein said display means further comprise liquid crystal diode display means.

7. The television monitor of claim 3 wherein said eyeglasses further comprise polarizing means, whereby light having one or the other of said two orthogonal linear polarizations may be passed therethrough to a user.

8. The television monitor of claim 7 wherein said polarizing means comprise a layer of polarizing glass.

9. The television monitor of claim 7 further comprising alignment means, whereby said layer of polarizing glass may be aligned with a selected one or the other of said two orthogonal linear polarizations for passage therethrough of said light having one or the other of said two orthogonal linear polarizations.

10. The television monitor of claim 10 wherein said alignment means comprise a pivot pin rotatably interconnecting a clear glass lens and a polarizing glass lens.

11. The television monitor of claim 10 further comprising automatic adjustment means whereby, upon movement of a user such as to change the angular orientation of said eyeglasses relative to said display means, the angular orientation of said polarizing means will be adjusted to maintain a desired alignment with said selected one or the other of said two orthogonal linear polarizations.

12. The television monitor of claim 11 wherein said automatic adjustment means comprise an anchor weight attached to said polarized glass lens.

13. Eyeglasses having polarization means adapted to pass therethrough particular ones of a number of orthogonally linearly polarized display images.

14. The eyeglasses of claim 13 wherein said polarizing means comprise a layer of polarizing glass.

15. The eyeglasses of claim 14 further comprising alignment means, whereby said layer of polarizing glass may be aligned with particular ones of a number of linearly polarized display images.

16. The eyeglasses of claim 15 wherein said alignment means comprise a pivot pin rotatably interconnecting a clear glass lens and a polarizing glass lens.

17. The eyeglasses of claim 15 further comprising automatic adjustment means whereby, upon movement of a user such as to change the angular orientation of said eyeglasses relative to a source of said number of linearly polarized display images, the angular orientation of said polarizing means will be adjusted to maintain a desired alignment with a selected one of said number of linearly polarized display images.

18. The eyeglasses of claim 18 wherein said automatic adjustment means comprise an anchor weight attached to said polarized glass lens.

19. A method of simultaneously displaying two video programs on a television display screen, together with means for a user to select one or the other of said two video programs, comprising:
1) Providing two mutually distinguishable television programs to a television monitor;
2) Modulating each said program separately so as to delete pixels from every other pixel site in each said program so as to produce two complementary subsets of pixels, each said subset of pixels having one-half of the number of the pixels as were in said programs as originally received, and such that the pixel locations at which said pixels are left intact with respect to one program are the pixel locations from which the pixels were removed in the other program, and vice versa;
3) Directing the resultant two subsets of said pixel locations into separate video streams that are then passed on to a multiplexor;
4) Merging together the content of said two video streams to produce a full screen of pixels, wherein the video information that is to appear in a resultant entirety of said pixel locations is derived alternately from one or the other of said two programs;
5) On the monitor screen, providing said two video streams that carry said two different subsets of pixel data as a single display made up of interlaced subsets of alternating ones of said pixels;
6) Causing the light emitted respectively from said two subsets of pixel data to have mutually orthogonal polarizations;
7) Providing eyeglasses having polarizing lenses therein to users for purposes of program selection; and
8) Aligning said eyeglasses while being worn by a user so that the polarizations of said polarized lenses are in orientations corresponding to those of said mutually orthogonal polarizations within the light emitted by the screen; and
9) Selecting one or the other of said two programs available on the screen, so as then to see one or the other of said two programs.
